(19) United States
(12) Patent Application Publication
(10) Pub. No.: US 2019/0041764 A1
(43) Pub. Date: Feb. 7, 2019

(54) POSITIVELY-CHARGEABLE BLACK TONER

(71) Applicant: ZEON CORPORATION, Tokyo (JP)

(72) Inventor: Ryo Tsumura, Tokyo (JP)

(73) Assignee: ZEON CORPORATION, Tokyo (JP)

(21) Appl. No.: 16/086,852

(22) PCT Filed: Mar. 24, 2017
(86) PCT No.: PCT/JP2017/012172

§ 371 Date: Sep. 20, 2018

(30) Foreign Application Priority Data
Mar. 31, 2016 (JP) 2016-070063

(51) Int. Cl. G03G 9/097; G03G 9/09; G03G 9/08; G03G 9/087

(52) U.S. Cl. CPC G03G 9/0975; G03G 9/0904; G03G 9/08711; G03G 9/0827; G03G 9/0819

(57) ABSTRACT

The positively-chargeable black toner includes colored resin particles containing a binder resin, carbon black and, as a charge control resin, a quaternary ammonium salt group-containing copolymer, wherein the quaternary ammonium salt group-containing copolymer is a styrene acrylic polymer containing a quaternary ammonium salt group-containing (meth)acrylate monomer unit; wherein a copolymerization ratio of the quaternary ammonium salt group-containing (meth)acrylate monomer in the quaternary ammonium salt group-containing copolymer, is in a range of from 0.1% by mass to 2.5% by mass. A content of the carbon black is in a range of from 10 parts by mass to 15 parts by mass with respect to 100 parts by mass of the binder resin. A blow-off charge amount of the colored resin particles measured by a specific charge amount measuring method, is in a range of from 5 μC/g to 60 μC/g.

### TECHNICAL FIELD

The present invention relates to a positively-chargeable black toner that can be used for development in electrophotographic image forming devices, such as a copy machine, a facsimile machine and a printer.

### BACKGROUND ART

In recent years, there is an increasing need for electrophotographic color image forming devices such as a multifunctional printer, a facsimile machine and a printer. In color printing, processes of image printing may be required to reproduce color tones with high-resolution and vividness comparable to photographs. Accordingly, there is a demand for color toners that can meet the request. Such toners are required to have various kinds of printing properties such as: environmental stability from the viewpoint of preventing a deterioration in image quality due to an environmental change in temperature, humidity, etc.; printing durability from the viewpoint of reducing printing costs; and low-temperature fixability from the viewpoint of reducing power consumption.

To meet the request, a spherical toner with a small particle diameter is suitable, since it can achieve both excellent transferability and dot reproducibility. As the method for producing the toner, a polymerization method has been proposed. In the case of a conventional pulverization method, especially in the case of producing a toner with a small particle diameter by the method, a low yield is obtained, and a lot of energy is consumed for pulverization. Meanwhile, in the case of the polymerization method, a high yield is obtained; energy consumption is low since a pulverization process is not necessary; and a spherical toner can be easily produced.

To produce a toner by the polymerization method (hereinafter, the toner will be referred to as “polymerized toner”), a suspension polymerization method, an emulsion polymerization method, a dispersion polymerization method, etc., can be used. In the suspension polymerization method, first, a polymerizable monomer, a colorant and, as needed, other additives are mixed to prepare a polymerizable monomer composition, and the composition is dispersed in an aqueous dispersion medium comprising a dispersion stabilizer. Next, using a high-speed agitator or the like, the aqueous dispersion medium in which the polymerizable monomer composition is dispersed, is subjected to high shear, thereby forming the polymerizable monomer composition into droplets. Then, the aqueous dispersion medium in which the droplets of the polymerizable monomer composition are dispersed, is polymerized in the presence of a polymerization initiator, followed by filtration using a filtering material, washing and drying, thereby obtaining colored resin particles. Moreover, the colored resin particles are mixed with an external additive such as inorganic fine particles, thereby obtaining a polymerized toner.

As just described, in the case of obtaining colored resin particles by the polymerization method, there is an advantage in that at the step of forming particles (the step of forming and polymerizing droplets in the case of the polymerization method, and the step of pulverization in the case of the pulverization method), spherical colored resin particles with a smaller particle diameter and a narrower particle size distribution than those produced by the conventional pulverization method, can be formed.

However, in recent years, along with a further increase in the level of demand for high resolution and high quality, it has been pointed out that even the polymerized toner has problems needed to be solved.

Image density is increased when a black toner is produced by, in order to obtain high image density that can meet the above demand level, increasing the amount of carbon black (CB) used as a colorant. However, there is a problem in that voids, fog and so on are likely to occur.

When a highly-chargeable charge control agent is used in order to solve this problem, the carbon black is likely to aggregate. Therefore, image density cannot be increased even when the amount of the carbon black is increased.

As a method for solving the problem, Patent Literature 1 discloses a toner for electrostatic charge image development, which comprises at least a binder resin, carbon black, a release agent, a naphthalene sulfonic acid formalin condensate, and at least one kind of anionic surfactant having a sulfonic group or a sulfuric acid ester group. In Patent Literature 1, it is described that aggregation of the carbon black can be inhibited by steric hindrance of the naphthalene sulfonic acid formalin condensate, and fog generation, which is caused by charge leakage of the toner, can be inhibited. It is also described that by using the naphthalene sulfonic acid formalin condensate in combination with the at least one kind of anionic surfactant having a sulfonic group or a sulfuric acid ester group, adsorption of the naphthalene sulfonic acid formalin condensate onto the carbon black can be inhibited, and generation of free carbon black can be inhibited; therefore, fog inhibition and image density keeping can be achieved more easily.

### CITATION LIST

Patent Literature 1: Japanese Patent Application Laid-Open No. 2012-208219

However, the toner of Patent Literature 1 has a problem in that sufficient image density cannot be obtained, while fog is inhibited.

### SUMMARY OF INVENTION

### Technical Problem

An object of the present invention is to solve the above problem and provide a positively-chargeable black toner which can inhibit fog and which can produce sharp black color on a printed surface of a sheet, even in such a condition that the amount of the toner on the sheet is small.

### Solution to Problem

As a result of considerable research, the inventor of the present invention found that the above problem can be solved by using a specific quaternary ammonium salt group-containing copolymer as a charge control resin and controlling the blow-off charge amount of colored resin particles measured by a specific method in a specific range.

According to the present invention, a positively-chargeable black toner is provided, the toner comprising colored resin particles containing a binder resin, carbon black and, as a charge control resin, a quaternary ammonium salt group-containing copolymer, wherein the quaternary ammonium salt group-containing copolymer is a styrene acrylic polymer containing a quaternary ammonium salt group-containing (meth)acrylate monomer unit; wherein a copolymerization ratio of the quaternary ammonium salt group-containing (meth)acrylate monomer in the quaternary ammonium salt group-containing copolymer, is in a range of from 0.1% by mass to 2.5% by mass; wherein a content of the carbon black is in a range of from 10 parts by mass to 15 parts by mass with respect to 100 parts by mass of the binder resin; and wherein a blow-off charge amount of the colored resin particles measured by a charge amount measuring method mentioned below, is in a range of from 5 μC/g to 60 μC/g.

[Charge Amount Measuring Method]

First, 0.25 g of the colored resin particles and 9.75 g of a ferrite carrier (spherical, non-resin-coated) are put in a 30 cc glass container (inside bottom diameter: 30 mm, height: 50 mm); using a roller mixer, the glass container is rotated at 160 rotations per minute (rpm) for 30 minutes to carry out a triboelectric charging treatment in an environment of 23° C. and a relative humidity of 50%; after the triboelectric charging treatment, 0.2 g of a mixture of the colored resin particles and the ferrite carrier is put in a Faraday gauge; and using a blow-off powder charge amount measuring device, the blow-off charge amount (μC/g) of the colored resin particles is measured by blowing off for 30 seconds in a condition of a nitrogen gas pressure of 0.098 MPa.

The positively-chargeable black toner of the present invention is preferably a polymerized toner.

In the present invention, the ferrite carrier used in the charge amount measuring method is preferably a standard carrier EF-80B2 (product name, manufactured by: Powdertech Corporation, Mn—Mg—Sr—Fe-based, spherical, non-resin coated, particle diameter: 80 μm), and the blow-off powder charge amount measuring device is preferably MODEL TB200 (product name, manufactured by: Toshiba Chemical Corporation).

### Advantageous Effects of Invention

As described above, according to the present invention, the positively-chargeable black toner which can inhibit fog and which can produce sharp black color on a printed surface of a sheet, even in such a condition that the amount of the toner on the sheet is small, can be provided by containing the colored resin particles that contains the specific quaternary ammonium salt group-containing copolymer as the charge control resin and has a blow-off charge amount in a range of from 5 μC/g to 60 μC/g.

### DESCRIPTION OF EMBODIMENTS

The positively-chargeable black toner of the present invention is a positively-chargeable black toner comprising colored resin particles containing a binder resin, carbon black and, as a charge control resin, a quaternary ammonium salt group-containing copolymer, wherein the quaternary ammonium salt group-containing copolymer is a styrene acrylic polymer containing a quaternary ammonium salt group-containing (meth)acrylate monomer unit; wherein a copolymerization ratio of the quaternary ammonium salt group-containing (meth)acrylate monomer in the quaternary ammonium salt group-containing copolymer, is in a range of from 0.1% by mass to 2.5% by mass; wherein a content of the carbon black is in a range of from 10 parts by mass to 15 parts by mass with respect to 100 parts by mass of the binder resin; and wherein a blow-off charge amount of the colored resin particles measured by a charge amount measuring method mentioned below, is in a range of from 5 μC/g to 60 μC/g.

[Charge Amount Measuring Method]

First, 0.25 g of the colored resin particles and 9.75 g of a ferrite carrier (spherical, non-resin-coated) are put in a 30 cc glass container (inside bottom diameter: 30 mm, height: 50 mm); using a roller mixer, the glass container is rotated at 160 rotations per minute (rpm) for 30 minutes to carry out a triboelectric charging treatment in an environment of 23° C. and a relative humidity of 50%; after the triboelectric charging treatment, 0.2 g of a mixture of the colored resin particles and the ferrite carrier is put in a Faraday gauge; and using a blow-off powder charge amount measuring device, the blow-off charge amount (μC/g) of the colored resin particles is measured by blowing off for 30 seconds in a condition of a nitrogen gas pressure of 0.098 MPa.

In the present invention, the term “(meth)acrylate” encompasses both acrylate and methacrylate. Also in the present invention, the term “(meth)acrylamide” encompasses both acrylamide and methacrylamide.

Hereinafter, the positively-chargeable black toner (hereinafter it may be simply referred to as “toner”) of the present invention will be described.

The toner of the present invention comprises colored resin particles containing a binder resin, carbon black and, as a charge control resin, a quaternary ammonium salt group-containing copolymer.

Hereinafter, a method for producing colored resin particles constituting the toner of the present invention, the colored resin particles obtained by the production method, a method for producing the toner of the present invention using the colored resin particles, and the toner of the present invention will be described in this sequence.

1. Method for Producing Colored Resin Particles

In general, methods for producing colored resin particles are broadly classified into dry methods such as a pulverization method and wet methods such as an emulsion polymerization agglomeration method, a suspension polymerization method and a solution suspension method. Wet methods are preferred since toners having excellent printing properties such as image reproducibility can be easily obtained. Among wet methods, polymerization methods such as an emulsion polymerization agglomeration method and a suspension polymerization method are preferred, since toners having a relatively small particle size distribution on a micron scale, can be easily obtained. Among polymerization methods, a suspension polymerization method is more preferred.

The emulsion polymerization agglomeration method is a method for producing colored resin particles by polymerizing emulsified polymerizable monomers to obtain a resin microparticle emulsion, and aggregating the resulting resin microparticles with a colorant dispersion, etc. The solution suspension method is a method for producing colored resin particles by forming a solution into droplets in an aqueous medium, the solution containing toner components such as a binder resin and a colorant dissolved or dispersed in an organic solvent, and removing the organic solvent. Both methods can be carried out by known methods.

The colored resin particles constituting the toner of the present invention can be produced by employing the wet method or the dry method. In the case of producing the colored resin particles by (A) the suspension polymerization method, which is preferred among the wet methods, or by (B) the pulverization method, which is typical among the dry methods, the production is carried out by the following processes.

(A) Suspension Polymerization Method

(A-1) Preparation Process of Polymerizable Monomer Composition

First, a polymerizable monomer, carbon black, a quaternary ammonium salt group-containing copolymer (as a charge control resin) and other additives added as needed, such as a softening agent, a molecular weight modifier and a release agent, are mixed to prepare a polymerizable monomer composition. For example, a media type dispersing machine is used for the mixing in the preparation of the polymerizable monomer composition.

In the present invention, the polymerizable monomer means a monomer having a polymerizable functional group, and the polymerizable monomer is polymerized into a binder resin. As a main component of the polymerizable monomer, a monovinyl monomer is preferably used. As the monovinyl monomer, examples include styrene; styrene derivatives such as vinyl toluene and α-methylstyrene; acrylic acid and methacrylic acid; acrylic acid esters such as methyl acrylate, ethyl acrylate, propyl acrylate, butyl acrylate, 2-ethylhexyl acrylate and dimethylaminoethyl acrylate; methacrylic acid esters such as methyl methacrylate, ethyl methacrylate, propyl methacrylate, butyl methacrylate, 2-ethylhexyl methacrylate and dimethylaminoethyl methacrylate; nitrile compounds such as acrylonitrile and methacrylonitrile; amide compounds such as acrylamide and methacrylamide; and olefins such as ethylene, propylene and butylene. These monovinyl monomers may be used alone or in combination of two or more kinds. Of them, styrene, styrene derivatives, and acrylic acid esters or methacrylic acid esters are preferably used as the monovinyl monomer.

To improve hot offset and heat-resistant storage stability, it is preferable to use a crosslinkable polymerizable monomer together with the monovinyl monomer. The crosslinkable polymerizable monomer means a monomer having two or more polymerizable functional groups. As the crosslinkable polymerizable monomer, examples include aromatic divinyl compounds such as divinyl benzene, divinyl naphthalene and derivatives thereof; ester compounds such as ethylene glycol dimethacrylate and diethylene glycol dimethacrylate, in which two or more carboxylic acids having a carbon-carbon double bond are esterified to alcohol having two or more hydroxyl groups; other divinyl compounds such as N,N-divinylaniline and divinyl ether; and compounds having three or more vinyl groups. These crosslinkable polymerizable monomers can be used alone or in combination of two or more kinds.

In the present invention, the amount of the crosslinkable polymerizable monomer used is generally from 0.1 part by mass to 5 parts by mass, and preferably from 0.3 part by mass to 2 parts by mass, with respect to 100 parts by mass of the monovinyl monomer.

Also, it is preferable to use a macromonomer as a part of the polymerizable monomer, since the balance between the storage stability and low-temperature fixability of the toner thus obtained can be excellent. The macromonomer is a reactive oligomer or polymer having a polymerizable carbon-carbon unsaturated double bond at the end of a polymer chain and generally having a number average molecular weight of froth 1,000 to 30,000. The macromonomer is preferably one that can provide a polymer having a higher glass transition temperature (hereinafter may be referred to as “Tg”) than a polymer obtained by polymerizing the monovinyl monomer.

The amount of the macromonomer used is preferably from 0.03 part by mass to 5 parts by mass, and more preferably from 0.05 part by mass to 1 part by mass, with respect to 100 parts by mass of the monovinyl monomer.

In the present invention, the carbon black is used as a colorant. The amount of the carbon black used is generally from 10 parts by mass to 15 parts by mass, and preferably 10 parts by mass to 13 parts by mass, with respect to 100 parts by mass of the monovinyl monomer. By adding the carbon black in the range, the content of the carbon black in the toner of the present invention can be in a range of from 10 parts by mass to 15 parts by mass, with respect to 100 parts by mass of the binder resin.

In the present invention, the quaternary ammonium salt group-containing copolymer is used as the charge control resin, which is a styrene acrylic polymer containing a quaternary ammonium salt group-containing (meth)acrylate monomer unit. This quaternary ammonium salt group-containing copolymer may be referred to as charge control resin.

The quaternary ammonium salt group-containing copolymer is sufficiently colorless for obtaining a black toner. By copolymerizing the quaternary ammonium salt group-containing (meth)acrylate monomer, the quaternary ammonium salt group can be contained in the copolymer; therefore, the quaternary ammonium salt group-containing copolymer can be used as a positively-chargeable charge control resin.

The copolymerization ratio of the quaternary ammonium salt group-containing (meth)acrylate monomer in the quaternary ammonium salt group-containing copolymer, is in a range of from 0.1% by mass to 2.5% by mass, preferably in a range of from 0.5% by mass to 2.0% by mass, and more preferably in a range of from 1.0% by mass to 1.5% by mass.

The quaternary ammonium salt group-containing copolymer can be produced by the following methods, for example.

(a) A method to obtain the quaternary ammonium salt group-containing copolymer by copolymerizing a vinyl monomer with the quaternary ammonium salt group-containing (meth)acrylate monomer

(b) A method to obtain the quaternary ammonium salt group-containing copolymer by reacting the copolymer obtained by the method (a) with para-toluenesulfonic acid, methanesulfonic acid or the like

(c) A method to obtain the quaternary ammonium salt group-containing copolymer by copolymerizing a vinyl monomer with a dialkylaminoalkyl (meth)acrylate monomer and quaternizing nitrogen atoms of dialkylaminoalkyl groups in the thus-obtained copolymer with a quaternizing agent

As the quaternary ammonium salt group-containing (meth)acrylate monomer, examples include N,N,N-trimethyl-N-(2-methacryloxyethyl)ammonium chloride (DMC or dimethylaminoethyl methacrylate methyl chloride) and N-benzyl-N,N-dimethyl-N-(2-methacryloxyethyl)ammonium chloride (DML or dimethylaminoethyl methacrylate benzyl chloride). These monomers can be used alone or in combination of two or more kinds.

As the dialkylaminoalkyl (meth)acrylate monomer, examples include dimethylaminoethyl (meth)acrylate, diethylaminoethyl (meth)acrylate, dipropylmethylaminoethyl (meth)acrylate, and dibutylaminoethyl (meth)acrylate. These monomers can be used alone or in combination of two or more kinds.

As the quaternizing agent, examples include halogenated organic compounds such as methyl chloride, methyl bromide, ethyl chloride, ethyl bromide, benzyl chloride and benzyl bromide, and sulfonic acid alkyl esters such as methylsulfonic acid alkyl ester, ethylsulfonic acid alkyl ester, propylsulfonic acid alkyl ester, benzenesulfonic acid alkyl ester, and para-toluenesulfonic acid alkyl ester. They can be used alone or in combination of two or more kinds.

As the vinyl monomer, a vinyl aromatic hydrocarbon monomer, a (meth)acrylate monomer and so on, which are those described above in relation to the polymerizable monomer, are preferably used.

As the vinyl aromatic hydrocarbon monomer, examples include styrene, α-methylstyrene, 2-methylstyrene, 3-methylstyrene, 4-methylstyrene, 2-ethylstyrene, 3-ethylstyrene, 4-ethylstyrene, 2-propylstyrene, 3-propylstyrene, 4-propylstyrene, 2-isopropylstyrene, 3-isopropylstyrene, 4-isopropylstyrene, 2-chlorostyrene, 3-chlorostyrene, 4-chlorostyrene, 2-methyl-α-methylstyrene, 3-methyl-α-methylstyrene, 4-methyl-α-methylstyrene, 2-ethyl-α-methylstyrene, 3-ethyl-α-methylstyrene, 4-ethyl-α-methylstyrene, 2-propyl-α-methylstyrene, 3-propyl-α-methylstyrene, 4-propyl-α-methylstyrene, 2-isopropyl-α-methylstyrene, 3-isopropyl-α-methylstyrene, 4-isopropyl-α-methylstyrene, 2-chloro-α-methylstyrene, 3-chloro-α-methylstyrene, 4-chloro-α-methylstyrene, 2,3-dimethylstyrene, 3,4-dimethylstyrene, 2,4-dimethylstyrene, 2,6-dimethylstyrene, 2,3-diethylstyrene, 3,4-diethylstyrene, 2,4-diethylstyrene, 2,6-diethylstyrene, 2-methyl-3-ethylstyrene, 2-methyl-4-ethylstyrene, 2-chloro-4-methylstyrene, 2,3-dimethyl-α-methylstyrene, 3,4-dimethyl-α-methylstyrene, 2,4-dimethylstyrene, 2,6-dimethyl-α-methylstyrene, 2,3-diethyl-α-methylstyrene, 3,4-diethyl-α-methylstyrene, 2,4-diethyl-α-methylstyrene, 2,6-diethyl-α-methylstyrene, 2-ethyl-3-methyl-α-methylstyrene, 2-methyl-4-propyl-α-methylstyrene, and 2-chloro-4-ethyl-α-methylstyrene. These monomers can be used alone or in combination of two or more kinds.

As the (meth)acrylate monomer, examples include the following (meth)acrylate compounds having no quaternary ammonium salt group (they will be simply referred to as (meth)acrylate compounds): acrylic acid esters such as methyl acrylate, ethyl acrylate, propyl acrylate, isopropyl acrylate, n-butyl acrylate, isobutyl acrylate, n-amyl acrylate, isoamyl acrylate, n-hexyl acrylate, 2-ethylhexyl acrylate, hydroxypropyl acrylate and lauryl acrylate, and methacrylic acid esters such as methyl methacrylate, ethyl methacrylate, propyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, hydroxypropyl methacrylate and lauryl methacrylate. These monomers can be used alone or in combination of two or more kinds.

In the present invention, the glass transition temperature (Tg) of the charge control resin is preferably from 60° C. to 90° C., more preferably from 65° C. to 85° C., and even more preferably from 70° C. to 80° C. When the glass transition temperature is in the range, the balance between the storage stability and fixability of the toner can be excellent.

The mass average molecular weight (Mw) of the quaternary ammonium salt group-containing copolymer is preferably from 8,000 to 28,000, more preferably from 10,000 to 25,000, and even more preferably from 15,000 to 23,000.

When the mass average molecular weight (Mw) of the quaternary ammonium salt group-containing copolymer is in the range, the quaternary ammonium salt group-containing copolymer can be dispersed well in the polymerizable monomer composition, and the toner thus obtained is provided with a stable charge amount over time. When the mass average molecular weight (Mw) of the quaternary ammonium salt group-containing copolymer is less than 8,000, the storage stability and printing durability of the toner may decrease. On the other hand, when the mass average molecular weight (Mw) of the quaternary ammonium salt group-containing copolymer is more than 28,000, the fixability of the toner may decrease.

As the quaternary ammonium salt group-containing copolymer, various kinds of commercial products can be used. As the commercial products, examples include FCA-676P (product name, manufactured by: Fujikura Kasei Co., Ltd., Tg: 73° C., weight average molecular weight (Mw): 19,500) in which the copolymerization ratio of the quaternary ammonium salt group-containing acrylate monomer is 1% by mass, and FCA-592P (product name, manufactured by: Fujikura Kasei Co., Ltd., Tg: 82° C., weight average molecular weight (Mw): 12,000) in which the copolymerization ratio of the quaternary ammonium salt group-containing acrylate monomer is 2% by mass.

The amount of the charge control resin used is preferably from 0.5 part by mass to 5.5 parts by mass, and more preferably from 1.0 part by mass to 5.0 parts by mass, with respect to 100 parts by mass of the monovinyl monomer.

When the added amount of the charge control resin is in the range, in the colored resin particles constituting the toner of the present invention, the content of the quaternary ammonium salt group-containing (meth)acrylate monomer unit, which is a component constituting the charge control resin, can be in a range of from 0.034 part by mass to 0.050 part by mass, with respect to 100 parts by mass of the binder resin. Therefore, the charge amount of the thus-obtained colored resin particles can be easily controlled.

A softening agent is preferably used as another additive. As the softening agent, a monoester compound having a structure represented by the following general formula (1) is preferably used:

R¹—COO—R² General Formula (1)

wherein R¹ is a straight-chain alkyl group having 15 carbon atoms to 23 carbon atoms, and R² is, a straight-chain alkyl group having 16 carbon atoms to 24 carbon atoms.

R¹ and R² may be the same or different groups.

In the monoester compound represented by the general formula (1), the difference between the carbon number of raw material fatty acid (i.e., the carbon number obtained by adding 1 to the carbon number of R¹) and the carbon number of raw material alcohol (i.e., the carbon number of R²) is preferably from 0 to 6, and more preferably from 4 to 6.

As the monoester compound represented by the general formula (1), examples include eicosyl palmitate (C₁₅H₃₁—COO—C₂₀H₄₁), behenyl palmitate (C₁₅H₃₁—COO—C₂₂H₄₅), stearyl stearate (C₁₇H₃₅—COO—C₁₈H₃₇), eicosyl stearate (C₁₇H₃₅—COO—C₂₀H₄₁), behenyl stearate (C₁₇H₃₅—COO—C₂₂H₄₅), hexadecyl eicosanoate (C₁₉H₃₉—COO—C₁₆H₃₃), stearyl eicosanoate (C₁₉H₃₉—COO—C₁₈H₃₇), eicosyl eicosanoate (C₁₉H₃₉—COO—C₂₀H₄₁), hexadecyl behenate (C₂₁H₄₃—COO—C₁₆H₃₃), stearyl behenate (C₂₁H₄₃—COO—C₁₈H₃₇), eicosyl behenate (C₂₁H₄₃—COO—C₂₀H₄₁), behenyl behenate (C₂₁H₄₃—COO—C₂₂H₄₅), and hexadecyl lignocerate (C₂₃H₄₇—COO—C₁₆H₃₃). Of these monoester compounds, behenyl palmitate, eicosyl palmitate, behenyl stearate, eicosyl eicosanoate, hexadecyl behenate, stearyl behenate and behenyl behenate are preferred, and behenyl palmitate, behenyl stearate and eicosyl eicosanoate are more preferred.

In general, the hydroxyl value of the softening agent is preferably 10 mgKOH/g or less, more preferably 6 mgKOH/g or less, and even more preferably 3 mgKOH/g or less. When the hydroxyl value is larger than 10 mgKOH/g, the heat-resistant storage stability of the toner may deteriorate. The hydroxyl value of the softening agent is a value measured in conformity to JIS K 0070, which is a standard method for the analysis of fats and oils established by Japanese Industrial Standards Committee (JISC).

In general, the added amount of the softening agent is preferably from 10 parts by mass to 30 parts by mass, with respect to 100 parts by mass of the polymerizable monomer (preferably the monovinyl monomer). Even in the case of using two or more kinds of softening agents, generally, the total added amount of the softening agents is preferably from 10 parts by mass to 30 parts by mass, with respect to 100 parts by mass of the polymerizable monomer. When the added amount is less than 10 parts by mass, the low-temperature fixability of the toner may deteriorate. When the added amount is more than 30 parts by mass, the heat-resistant storage stability of the toner may deteriorate.

The added amount of the softening agent is more preferably from 10 parts by mass to 25 parts by mass, and even more preferably from 12 parts by mass to 22 parts by mass, with respect to 100 parts by mass of the polymerizable monomer.

The melting point of the softening agent is preferably from 60° C. to 75° C., more preferably from 63° C. to 72° C., and even more preferably from 65° C. to 70° C. When the melting point of the softening agent is less than 60° C., the toner may have poor heat-resistant storage stability. When the melting point of the softening agent is more than 75° C., the low-temperature fixability of the toner may deteriorate.

The melting point of the softening agent can be determined as follows: for example, using a differential scanning calorimeter (product name: DSC-6220, manufactured by: Seiko Instruments, Inc.), measurement is carried out at a temperature increase rate of 100 ° C./min in a specific temperature range, and the top of a peak in a DSC curve thus obtained is determined as the melting point (TmD).

As the method for producing the monoester compound used as the softening agent, examples include a method of synthesis by an oxidation reaction, synthesis from carboxylic acid and derivatives thereof, ester group introducing reactions as typified by the Michael addition reaction, a method using a dehydration-condensation reaction from a carboxylic acid compound and an alcohol compound, a reaction from an acid halide and an alcohol compound, and an ester-exchange reaction. In the production of the monoester compound, a catalyst can be appropriately used. As the catalyst, a general acidic or alkaline catalyst used in an esterification reaction, such as zinc acetate or a titanium compound, is preferred. After the esterification reaction, a target product may be purified by recrystallization, distillation, etc.

A typical example of the method for producing the monoester compound is as follows. The monoester compound production method used in the present invention is not limited to the following typical example.

First, alcohol and carboxylic acid, which are raw materials, are put in a reaction container. The molar ratio of the alcohol to the carboxylic acid is appropriately controlled depending on the chemical structure of the target softening agent. That is, in the case of the monoester compound, the alcohol and the carboxylic acid are mixed at a molar ratio of 1:1. Considering reactivity and so on, in the dehydration-condensation reaction, any one of the added alcohol and carboxylic acid may be slightly larger than the above-described molar ratio.

Next, the mixture is appropriately heated to initiate the dehydration-condensation reaction. A basic aqueous solution and, as needed, an organic solvent are added to an esterified crude reactant obtained by the dehydration-condensation reaction, thereby deprotonating unreacted alcohol and carboxylic acid and separating them into an aqueous phase. Then, water washing, solvent distillation, and filtration are appropriately carried out, thereby obtaining the desired monoester compound.

As another additive, a molecular weight modifier is preferably used in the polymerization of the polymerizable monomer that is polymerized into a binder resin.

The molecular weight modifier is not particularly limited, as long as it is one that is generally used as a molecular weight modifier for toners. As the molecular weight modifier, examples include mercaptans such as t-dodecyl mercaptan, n-dodecyl mercaptan, n-octyl mercaptan and 2,2,4,6,6-pentamethylheptane-4-thiol, and thiuram disulfides such as tetramethyl thiuram disulfide, tetraethyl thiuram disulfide, tetrabutyl thiuram disulfide, N,N′-dimethyl-N,N′-diphenyl thiuram disulfide, and N,N′-dioctadecyl-N,N′-diisopropyl thiuram disulfide. These molecular weight modifiers may be used alone or in combination of two or more kinds.

In the present invention, the amount of the molecular weight modifier used is generally from 0.01 part by mass to 10 parts by mass, and preferably from 0.1 part by mass to 5 parts by mass, with respect to 100 parts by mass of the monovinyl monomer.

To increase the removability of the toner from a fixing roller, a release agent is preferably used as another additive.

The release agent is not particularly limited, as long as it is one that is generally used as a release agent for toners. As the release agent, examples include polyolefin waxes such as low-molecular-weight polyethylene, low-molecular-weight polypropylene and low-molecular-weight polybutylene; natural waxes such as candelilla, carnauba, rice, Japan wax and jojoba; petroleum waxes such as paraffin, microcrystalline and petrolatum; mineral waxes such as montan, ceresin and ozokerite; synthetic waxes such as Fischer-Tropsch wax; and polyhydric alcohol ester compounds including pentaerythritol esters such as pentaerythritol tetramyristate, pentaerythritol tetrapalmitate, pentaerythritol tetrastearate and pentaerythritol tetralaurate, and dipentaerythritol esters such as dipentaerythritol hexamyristate, dipentaerythritol hexapalmitate and dipentaerythritol hexalaurate. These release agents may be used alone or in combination of two or more kinds.

In the present invention, the amount of the release agent used is generally from 0.1 part by mass to 30 parts by mass, and preferably from 1 part by mass to 20 parts by mass, with respect to 100 parts by mass of the monovinyl monomer. When the amount is small, the toner may not obtain sufficient releasability. On the other hand, when the amount is large, the storage stability of the toner may decrease.

(A-2) Suspension Process of Obtaining Suspension (Droplets Forming Process)

The polymerizable monomer composition obtained through the above-mentioned “(A-1) Preparation process of polymerizable monomer composition” is suspended in an aqueous dispersion medium to obtain a suspension (a polymerizable monomer composition dispersion). As used herein, “suspend” means forming the polymerizable monomer composition into droplets in the aqueous dispersion medium. For the droplets formation, a dispersion treatment can be carried out by means of a device capable of strong agitation, such as an (in-line type) emulsifying and dispersing machine (product name: MILDER, manufactured by: Pacific Machinery & Engineering Co., Ltd.) and a high-speed emulsifying and dispersing machine (product name: T. K. HOMOMIXER MARK II, manufactured by: PRIMIX Corporation).

As the polymerization initiator, examples include persulfates such as potassium persulfate and ammonium persulfate; azo compounds such as 4,4′-azobis(4-cyanovaleric acid), 2,2′-azobis(2-methyl-N-(2-hydroxyethyl)propionamide), 2,2′-azobis(2-amidinopropane)dihydrochloride, 2,2′-azobis(2,4-dimethylvaleronitrile) and 2,2′-azobisisobutyronitrile; and organic peroxides such as di-t-butylperoxide, benzoylperoxide, t-butylperoxy-2-ethylhexanoate, t-butylperoxy diethylacetate, t-hexylperoxy-2-ethylbutanoate, diisopropylperoxydicarbonate, di-t-butylperoxyisophthalate and t-butylperoxyisobutyrate. They can be used alone or in combination of two or more kinds. Of them, organic peroxides are preferred, since they can reduce residual polymerizable monomer and impart excellent printing durability.

Of organic peroxides, peroxy esters are preferred, and non-aromatic peroxy esters, i.e., peroxy esters having no aromatic ring are more preferred, since they have excellent initiator efficiency and can reduce residual polymerizable monomer.

The polymerization initiator may be added after the polymerizable monomer composition is dispersed in the aqueous dispersion medium and before the polymerizable monomer composition is formed into droplets as described above, or it may be added to the polymerizable monomer composition before the polymerizable monomer composition is dispersed in the aqueous dispersion medium.

The added amount of the polymerization initiator used for the polymerization of the polymerizable monomer composition, is preferably from 0.1 part by mass to 20 parts by mass, more preferably from 0.3 part by mass to 15 parts by mass, and even more preferably from 1 part by mass to 10 parts by mass, with respect to 100 parts by mass of the monovinyl monomer.

In the present invention, the aqueous dispersion medium means a medium containing water as a main component.

In the present invention, a dispersion stabilizer is preferably contained in the aqueous dispersion medium. As the dispersion stabilizer, examples include inorganic compounds including sulfates such as barium sulfate and calcium sulfate, carbonates such as barium carbonate, calcium carbonate and magnesium carbonate, phosphates such as calcium phosphate, metal oxides such as aluminum oxide and titanium oxide, and metal hydroxides such as aluminum hydroxide, magnesium hydroxide and iron(II) hydroxide, and organic compounds including water-soluble polymers such as polyvinyl alcohol, methyl cellulose and gelatin, an anionic surfactant, a nonionic surfactant and an ampholytic surfactant. These dispersion stabilizers can be used alone or in combination of two or more kinds.

Of the above dispersion stabilizers, preferred is a colloid of an inorganic compound, and particularly preferred is a colloid of a hardly water-soluble metal hydroxide. By using a colloid of an inorganic compound, particularly a colloid of a hardly water-soluble metal hydroxide, the colored resin particles can have a narrow particle size distribution, and the amount of the dispersion stabilizer remaining after washing can be small. Therefore, the toner thus obtained can clearly reproduce an image and has excellent environmental stability.

(A-3) Polymerization Process

The desired suspension (the aqueous dispersion medium containing the droplets of the polymerizable monomer composition) obtained by the above “(A-2) Suspension process of obtaining suspension (droplets forming process)” is polymerized by heating, thereby obtaining an aqueous dispersion of colored resin particles.

The polymerization temperature of the polymerizable monomer composition is preferably 50° C. or more, and more preferably from 60° C. to 95° C. The polymerization reaction time is preferably from 1 hour to 20 hours, and more preferably from 2 hours to 15 hours.

The colored resin particles may be mixed with an external additive and used as a polymerized toner. It is preferable that the colored resin particles are so-called core-shell type (or “capsule type”) colored resin particles obtained by using the colored resin particles as a core layer and forming a shell layer, which is a layer different from the core layer, around the core layer. By covering the core layer composed of a substance having a low softening point with a substance having a higher softening point, the core-shell type colored resin particles can achieve a balance between lowering of fixing temperature and prevention of aggregation during storage.

The method for producing the above-mentioned core-shell type colored resin particles using the colored resin particles, is not particularly limited. The core-shell type colored resin particles can be produced by conventional methods. The in situ polymerization method and the phase separation method are preferred from the viewpoint of production efficiency.

Hereinafter, a method for producing the core-shell type colored resin particles by the in situ polymerization method, will be described.

The core-shell type colored resin particles can be obtained by adding a polymerizable monomer for forming a shell layer (a polymerizable monomer for shell) and a polymerization initiator to the aqueous dispersion medium in which the colored resin particles are dispersed, and then polymerizing the mixture.

As the polymerizable monomer for shell, the above-mentioned polymerizable monomers can be used. Of them, it is preferable to use monomers that can provide a polymer having a Tg of more than 80° C., such as styrene, acrylonitrile and methyl methacrylate, alone or in combination of two or more kinds.

As the polymerization initiator used for polymerization of the polymerizable monomer for shell, examples include water-soluble polymerization initiators including metal persulfates such as potassium persulfate and ammonium persulfate, and azo-type initiators such as 2,2′-azobis(2-methyl-N-(2-hydroxyethyl)propionamide) and 2,2′-azobis(2-methyl-N-(1,1-bis(hydroxymethyl)2-hydroxyethyl)propionamide). These polymerization initiators can be used alone or in combination of two or more kinds. The amount of the polymerization initiator is preferably from 0.1 part by mass to 30 parts by mass, and more preferably from 1 part by mass to 20 parts by mass, with respect to 100 parts by mass of the polymerizable monomer for shell.

The polymerization temperature of the shell layer is preferably 50° C. or more, and more preferably from 60° C. to 95° C. The polymerization reaction time is preferably from 1 hour to 20 hours, and more preferably from 2 hours to 15 hours.

(A-4) Washing, Filtering, Dehydrating and Drying Processes

It is preferable that the aqueous dispersion of the colored resin particles obtained after the above “(A-3) Polymerization process” is repeatedly subjected to a series of washing, filtering, dehydrating and drying processes, several times as needed, according to a conventional method.

As the washing method, when the inorganic compound is used as the dispersion stabilizer, it is preferable that the dispersion stabilizer is dissolved in water and removed by adding acid or alkali to the aqueous dispersion of the colored resin particles. When the colloid of the hardly water-soluble inorganic hydroxide is used as the dispersion stabilizer, it is preferable to control the pH of the aqueous dispersion of the colored resin particles to 6.5 or less by adding acid. As the acid, inorganic acids such as sulfuric acid, hydrochloric acid and nitric acid, and organic acids such as formic acid and acetic acid, can be used. Sulfuric acid is particularly preferred for its high removal efficiency and small impact on production facilities.

The dehydrating and filtering method is not particularly limited and can be selected from various known methods. As the method, examples include a centrifugal filtration method, a vacuum filtration method and a pressure filtration method. Also, the drying method is not particularly limited and can be selected from various methods.

(B) Pulverization Method

In the case of producing the colored resin particles by employing the pulverization method, the colored resin particles are produced by the following processes.

First, a binder resin, carbon black, a quaternary ammonium salt group-containing copolymer (as a charge control resin) and other additives added as needed, such as a softening agent and a release agent, are mixed by means of a mixer such as a ball mill, a V-type mixer, FM MIXER (product name, manufactured by: Nippon Coke & Engineering Co., Ltd.), a high-speed dissolver or an internal mixer. Next, while heating the thus-obtained mixture, the mixture is kneaded by means of a press kneader, a twin screw kneading machine, a roller or the like. The thus-obtained kneaded product is coarsely pulverized by means of a pulverizer such as a hammer mill, a cutter mill or a roller mill, and then finely pulverized by means of a pulverizer such as a jet mill or a high-speed rotary pulverizer, thereby obtaining the colored resin particles produced by the pulverization method.

As the binder resin, the carbon black, the quaternary ammonium salt group-containing copolymer (as the charge control resin) and the other additives added as needed, such as the softening agent and the release agent, those that are provided under the above “(A) Suspension polymerization method” can be used in the pulverization method. Similarly to the colored resin particles obtained by the above “(A) Suspension polymerization method”, the colored resin particles obtained by the pulverization method can be made into core-shell type colored resin particles by a method such as the in situ polymerization method.

As the binder resin, resins that have been widely used for toners can be used. As the binder resin used in the pulverization method, examples include polystyrene, styrene-butyl acrylate copolymers, polyester resins and epoxy resins.

2. Colored Resin Particles

The colored resin particles contained in the toner of the present invention are obtained by the production method such as the above-mentioned “(A) Suspension polymerization method” or “(B) Pulverization method”.

Hereinafter, the colored resin particles constituting the toner will be described. The colored resin particles described below encompass both core-shell type colored resin particles and colored resin particles of other types.

The colored resin particles contained in the toner of the present invention contain a binder resin, carbon black and, as a charge control resin, a quaternary ammonium salt group-containing copolymer.

The content of the carbon black is in a range of from 10 parts by mass to 15 parts by mass, preferably from 11 parts by mass to 14 parts by mass, and even more preferably from 12 parts by mass to 13 parts by mass, with respect to 100 parts by mass of the binder resin.

For the colored resin particles constituting the toner of the present invention, the blow-off charge amount measured by a charge amount measuring method mentioned below, is in a range of from 5 μC/g to 60 μC/g, preferably in a range of from 10 μC/g to 50 μC/g, and even more preferably in a range of from 20 μC/g to 40 μC/g.

[Charge Amount Measuring Method]

First, 0.25 g of the colored resin particles and 9.75 g of a ferrite carrier (spherical, non-resin-coated) are put in a 30 cc glass container (inside bottom diameter: 30 mm, height: 50 mm); using a roller mixer, the glass container is rotated at 160 rotations per minute (rpm) for 30 minutes to carry out a triboelectric charging treatment in an environment of 23° C. and a relative humidity of 50%; after the triboelectric charging treatment, 0.2 g of a mixture of the colored resin particles and the ferrite carrier is put in a Faraday gauge; and using a blow-off powder charge amount measuring device, the blow-off charge amount (μC/g) of the colored resin particles is measured by blowing off for 30 seconds in a condition of a nitrogen gas pressure of 0.098 MPa.

The blow-off charge amount (μC/g) of the colored resin particles can be calculated by the following formula (1):

The blow-off charge amount (μC/g) of the colored resin particles=The blow-off charge amount (μC) of the mixture/the weight (0.2 g) of the mixture×the content ratio (2.5%) of the colored resin particles in the mixture Formula (1)

The ferrite carrier used in the charge amount measuring method is preferably a standard carrier EF-80B2 (product name, manufactured by: Powdertech Corporation, Mn—Mg—Sr—Fe-based, spherical, non-resin coated, particle diameter: 80 μm).

The blow-off powder charge amount measuring device is preferably MODEL TB200 (product name, manufactured by: Toshiba Chemical Corporation).

The volume average particle diameter (Dv) of the colored resin particles is preferably from 4 μm to 12 μm, and more preferably from 5 μm to 10 μm. When the volume average particle diameter (Dv) is less than 4 μm, toner flowability decreases and may deteriorate transferability or decrease image density. When the volume average particle diameter (Dv) is more than 12 μm, image resolution may decrease.

For the colored resin particles, the ratio (Dv/Dn) between the volume average particle diameter (Dv) and the number average particle diameter (Dn) is preferably from 1.0 to 1.3, and more preferably from 1.0 to 1.2. When the ratio Dv/Dn is more than 1.3, there may be a decrease in transferability, image density and resolution. The volume average particle diameter and number average particle diameter of the colored resin particles can be measured by means of a particle size analyzer (product name: MULTISIZER, manufactured by: Beckman Coulter, Inc.), for example.

The average circularity of the colored resin particles is preferably from 0.96 to 1.00, more preferably from 0.97 to 1.00, and even more preferably from 0.98 to 1.00, from the viewpoint of image reproducibility.

When the average circularity of the colored resin particles is less than 0.96, thin line reproducibility in printing may deteriorate.

In the present invention, “circularity” is defined as a value obtained by dividing the perimeter of a circle having the same area as the projected area of a particle image by the perimeter of the particle image. Also in the present invention, “average circularity” is used as a simple method for quantitatively representing the shape of the particles and is an indicator that shows the degree of the surface roughness of the colored resin particles. The average circularity is 1 when the colored resin particles are perfectly spherical, and it gets smaller as the surface shape of the colored resin particles becomes more complex.

In the colored resin particles contained in the toner of the present invention, the content of the charge control resin is preferably from 0.5 part by mass to 5.5 parts by mass, and more preferably from 1.0 part by mass to 5.0 parts by mass, with respect to 100 parts by mass of the binder resin.

The content of the quaternary ammonium salt group-containing (meth)acrylate monomer unit, which is a component constituting the charge control resin, is preferably from 0.034 part by mass to 0.050 part by mass, and more preferably from 0.037 part by mass to 0.040 part by mass, with respect to 100 parts by mass of the binder resin.

When the content of the charge control resin and that of the quaternary ammonium salt group-containing (meth)acrylate monomer unit are in the above ranges, the charge amount of the colored resin particles can be easily controlled in the above range.

When the content of the charge control resin or that of the quaternary ammonium salt group-containing (meth)acrylate monomer unit is less than the above range, the charge amount applied to the colored resin particles is insufficient and may have adverse effects on the printing performance of the toner. On the other hand, when the content of the charge control resin or that of the quaternary ammonium salt group-containing (meth)acrylate monomer unit is more than the above range, the charge amount is too large and may decrease the printing performance.

3. Method for Producing the Toner

In the present invention, it is preferable, that the colored resin particles are mixed and stirred with an external additive to attach the external additive to the surface of the colored resin particles, thereby obtaining a one-component toner (developer). The one-component toner may be mixed and stirred with carrier particles to obtain a two-component developer.

A mixer is used for the external addition, and the mixer is not particularly limited, as long as it is a mixing device that can attach the external additive to the surface of the colored resin particles. For example, the external addition can be carried out by means of a mixer that is capable of mixing and agitation, such as FM MIXER (product name, manufactured by: Nippon Coke & Engineering Co., Ltd.), SUPER MIXER (product name, manufactured by: Kawata Manufacturing Co., Ltd.), Q MIXER (product name, manufactured by: Nippon Coke & Engineering Co., Ltd.), MECHANOFUSION SYSTEM (product name, manufactured by: Hosokawa Micron Corporation) and MECHANOMILL (product name, manufactured by: Okada Seiko Co., Ltd.)

As the external additive, examples include inorganic fine particles made of silica, titanium oxide, aluminum oxide, zinc oxide, tin oxide, calcium carbonate, calcium phosphate and/or cerium oxide, and organic fine particles made of polymethyl methacrylate resin, silicone resin and/or melamine resin. Of them, inorganic fine particles are preferred. Of inorganic fine particles, silica and/or titanium oxide is preferred, and fine particles made of silica are particularly preferred.

These external additives can be used alone or in combination of two or more kinds. It is particularly preferable to use two or more kinds of silica fine particles having different particle diameters.

In the present invention, the amount of the external additive used is generally from 0.05 part by mass to 6 parts by mass, and preferably from 0.2 part by mass to 5 parts by mass, with respect to 100 parts by mass of the colored resin particles. When the added amount of the external additive is less than 0.05 part by mass, the toner may be left untransferred. When the added amount of the external additive is more than 6 parts by mass, fog may be generated.

4. Toner of the Present Invention

The toner of the present invention is a positively-chargeable black toner which is less likely to generate fog and which can produce sharp black color on a printed surface of a sheet, even in such a condition that the amount of the toner on a sheet is small.

### EXAMPLES

Hereinafter, the present invention will be described further in detail, with reference to examples and comparative examples. However, the scope of the present invention may not be limited to the following examples. Herein, “part(s)” and “%” are based on mass if not particularly mentioned.

Test methods carried out in the examples and the comparative examples are as follows.

1. Production of Colored Resin Particles

### Production Example 1

1-1. Preparation of Polymerizable Monomer Composition

First, 75 parts of styrene, 25 parts of n-butyl acrylate, 0.25 part of a polymethacrylic acid ester macromonomer (product name: AA6, manufactured by: TOAGOSEI Co., Ltd., Tg: 94° C.), 0.7 part of divinylbenzene and, as a black colorant, 10 parts of carbon black were dispersed by means of a media type emulsifying and dispersing machine (product name: DYNO-MILL, manufactured by: Shinmaru Enterprises Corporation) to obtain a polymerizable monomer mixture. To the mixture obtained by wet pulverization, 3.7 parts of a styrene acrylic polymer in which the copolymerization ratio of a quaternary ammonium salt group-containing acrylate monomer unit is 1% by mass (product name: ACRYBASE FCA-676P, manufactured by: Fujikura Kasei Co., Ltd.) as a charge control resin, 20 parts of an ester wax (product name: WE-6, manufactured by: NOF Corporation) and 1.0 part of tetraethylthiuram disulfide were added, mixed and then dissolved to prepare a polymerizable monomer composition.

1-2. Preparation of Aqueous Dispersion Medium

An aqueous solution of 7.3 parts of sodium hydroxide dissolved in 50 parts of ion-exchanged water, was gradually added to, while agitating, an aqueous solution of 10.4 parts of magnesium chloride dissolved in 280 parts of ion-exchanged water, thereby preparing a magnesium hydroxide colloid dispersion.

1-3. Formation of Droplets

The polymerizable monomer composition was added to the magnesium hydroxide colloid dispersion (the magnesium hydroxide colloid amount: 5.3 parts) and agitated. Then, 6 parts of t-butylperoxy-2-ethylhexanoate was added thereto as a polymerization initiator. The dispersion mixed with the polymerization initiator was dispersed by an in-line type emulsifying and dispersing machine (product name: MILDER MDN303V, manufactured by: Pacific Machinery & Engineering Co., Ltd.) at a rotational frequency of 15,000 rpm, thereby forming the polymerizable monomer composition into droplets.

1-4. Suspension Polymerization

The dispersion containing the droplets of the polymerizable monomer composition was put in a reactor, and the temperature thereof was increased to 90° C. to initiate a polymerization reaction. When a polymerization conversion rate reached almost 100%, methyl methacrylate and 0.1 part of 2,2′-azobis[2-methyl-N-(2-hydroxyethyl)-propionamide] (product name: VA-086, manufactured by: Wako Pure Chemical Industries, Ltd.) were added to the reactor as a polymerizable monomer for shell and a polymerization initiator for shell, respectively. Next, the polymerization was further continued by sustaining the reaction for 4 hours at 95° C. Then, the reaction was stopped by water-cooling the reactor, thereby obtaining an aqueous dispersion of core-shell type colored resin particles.

1-5. Post-Treatment Processes

The aqueous dispersion of the colored resin particles was subjected to acid washing (25° C., 10 minutes) in the following manner: while agitating the aqueous dispersion, sulfuric acid was added thereto until the pH of the aqueous dispersion reached 4.5 or less. Then, the aqueous dispersion was subjected to filtration separation to obtain the colored resin particles. The colored resin particles were washed with water, and the washing water was filtered. The filtrate had an electrical conductivity of 20 μS/cm at this time. Moreover, the colored resin particles subjected to the washing and filtering processes were dehydrated and dried, thereby obtaining dried colored resin particles (1) (circularity: 0.986, Dv: 5.8 μm, Dv/Dn: 1.14).

### Production Example 2

Colored resin particles (2) were obtained in the same manner as the colored resin particles (1) of Production Example 1, except that the added amount of the carbon black was changed to 11 parts.

### Production Example 3

Colored resin particles (3) were obtained in the same manner as the colored resin particles (1) of Production Example 1, except that the added amount of the carbon black was changed to 12 parts.

### Production Example 4

Colored resin particles (4) were obtained in the same manner as the colored resin particles (1) of Production Example 1, except that the added amount of the carbon black was changed to 13 parts.

### Production Example 5

Colored resin particles (5) were obtained in the same manner as the colored resin particles (1) of Production Example 1, except that the added amount of the carbon black was changed to 12 parts, and the added amount of FCA-676P was changed to 3.5 parts.

### Production Example 6

Colored resin particles (6) were obtained in the same manner as the colored resin particles (1) of Production Example 1, except that the added amount of the carbon black was changed to 12 parts, and the added amount of FCA-676P was changed to 4.7 parts.

### Production Example 7

Colored resin particles (7) were obtained in the same manner as the colored resin particles (1) of Production Example 1, except that 1.7 parts of a styrene acrylic polymer in which the copolymerization ratio of a quaternary ammonium salt group-containing acrylate monomer unit is 2% by mass (product name: ACRYBASE FCA-592P, manufactured by: Fujikura Kasei Co., Ltd.) was used as the charge control resin.

### Production Example 8

Colored resin particles (8) were obtained in the same manner as the colored resin particles (1) of Production Example 1, except that the added amount of the carbon black was changed to 12 parts, and 1.7 parts of FCA-592P was used as the charge control resin.

### Production Example 9

Colored resin particles (9) were obtained in the same manner as the colored resin particles (1) of Production Example 1, except that the added amount of the carbon black was changed to 8 parts, and 1.7 parts of FCA-592P was used as the charge control resin.

### Production Example 10

Colored resin particles (10) were obtained in the same manner as the colored resin particles (1) of Production Example 1, except that the added amount of the carbon black was changed to 8 parts, and 0.4 part of a styrene acrylic polymer in which the copolymerization ratio of a quaternary ammonium salt group-containing acrylate monomer unit is 8% by mass (product name: ACRYBASE FCA-161P, manufactured by: Fujikura Kasei Co., Ltd.) was used as the charge control resin.

### Production Example 11

Colored resin particles (11) were obtained in the same manner the colored resin particles (1) of Production Example 1, except that 0.4 part of FCA-161P was used as the charge control resin.

### Production Example 12

Colored resin particles (12) were obtained in the same manner as the colored resin particles (1) of Production Example 1, except that the added amount of the carbon black was changed to 12 parts, and 0.4 part of FCA-161P was used as the charge control resin.

### Production Example 13

Colored resin particles (13) were obtained in the same manner as the colored resin particles (1) of Production Example 1, except that the added amount of the carbon black was changed to 13 parts, and 0.4 part of FCA-161P was used as the charge control resin.

### Production Example 14

Colored resin particles (14) were obtained in the same manner as the colored resin particles (1) of Production Example 1, except that the added amount of the carbon black was changed to 12 parts, and 3.0 parts of FCA-676P was used as the charge control resin.

### Production Example 15

Colored resin particles (15) were obtained in the same manner as the colored resin particles (1) of Production Example 1, except that the added amount of the carbon black was changed to 12 parts, and 6.0 parts of FCA-676P was used as the charge control resin.

The circularity, Dv, and Dv/Dn of the colored resin particles (2) to (15) were almost the same as those of the colored resin particles (1).

2. Production of Toner

### Example 1

To 100 parts of the colored resin particles (1), 0.6 part of hydrophobized silica fine particles having an average particle diameter of 7 nm and 1 part of hydrophobized silica fine particles having an average particle diameter of 35 nm, were added. They were mixed by means of a high-speed mixer (product name: FM MIXER, manufactured by: Nippon Coke & Engineering Co., Ltd.), thereby obtaining the black toner of Example 1.

### Examples 2 to 8

Toners of Examples 2 to 8 were obtained in the same manner as Example 1, except that the colored resin particles (2), the colored resin particles (3), the colored resin particles (4), the colored resin particles (5), the colored resin particles (6), the colored resin particles (7) and the colored resin particles (8) were used in Example 2, Example 3, Example 4, Example 5, Example 6, Example 7 and Example 8, respectively.

### Comparative Examples 1 to 7

Toners of Comparative Examples 1 to 7 were obtained in the same manner as Example 1, except that the colored resin particles (9), the colored resin particles (10), the colored resin particles (11), the colored resin particles (12), the colored resin particles (13), the colored resin particles (14) and the colored resin particles (15) were used in Comparative Example 1, Comparative Example 2, Comparative Example 3, Comparative Example 4, Comparative Example 5, Comparative Example 6 and Comparative Example 7, respectively.

3. Evaluation of Characteristics of Colored Resin Particles

The characteristics of the colored resin particles (1) to (15) used in the toners of Examples 1 to 8 and Comparative Examples 1 to 7, were examined. The details are as follows.

(1) Measurement of Particle Diameter of Colored Resin Particles

The volume average particle diameter Dv of the colored resin particles was measured by means of a particle diameter measuring machine (product name: MULTISIZER, manufactured by: Beckman Coulter, Inc.) This measurement using the MULTISIZER was carried out in the following conditions:
Aperture diameter: 100 μm
Dispersion medium: ISOTON II (product name, manufactured by: Beckman Coulter, Inc.)
Concentration: 10%
Number of measured particles: 100,000 particles

More specifically, 0.2 g of the sample colored resin particles were put in a beaker. As a dispersant, an alkylbenzene sulfonic acid aqueous solution (product name: DRIWEL, manufactured by: Fujifilm Corporation) was added thereto. In addition, 2 mL of the dispersion medium was added to wet the colored resin particles. Then, 10 mL of the dispersion medium was added thereto, and the particles were dispersed for one minute with an ultrasonic disperser and then measured by the above-mentioned particle diameter measuring machine.

(2) Measurement of Charge Amount of Colored Resin Particles

First, 0.25 g of the colored resin particles and, as a standard carrier, 9.75 g of a ferrite carrier (product name: EF-80B2, manufactured by: Powdertech Corporation, Mn—Mg—Sr—Fe-based, spherical, non-resin coated, particle diameter: 80 μm) were put in a 30 cc glass container (inside bottom diameter: 30 mm, height: 50 mm); using a roller mixer, the glass container was rotated at 160 rotations per minute (rpm) for 30 minutes to carry out a triboelectric charging treatment in an environment of 23° C. and a relative humidity of 50%; after the triboelectric charging treatment, 0.2 g of a mixture of the colored resin particles and the ferrite carrier was put in a Faraday gauge; and using a blow-off powder charge amount measuring device (product name: MODEL TB200, manufactured by: Toshiba Chemical Corporation), the blow-off charge amount (μC) of the mixture was measured by blowing off for 30 seconds in a condition of a nitrogen gas pressure of 0.098 MPa. Then, the blow-off charge amount (μC/g) of the colored resin particles was calculated by the following formula (1):

The blow-off charge amount (μC/g) of the colored resin particles=The blow-off charge amount (μC) of the mixture/the weight (0.2 g) of the mixture×the content ratio (2.5%) of the colored resin particles in the mixture Formula (1)

(3) Measurement of Resistivity (Volume Resistivity) of Colored Resin Particles

The volume resistivity (log Ω/cm) of the colored resin particles was measured as follows. About 3 g of the colored resin particles was put in a tablet press machine having a diameter of 5 cm. A load of about 100 kg was applied thereto for one minute, thereby producing a test specimen. Using the test specimen, measurement was carried out by means of a dielectric loss measuring device (model: TRS-10, manufactured by: Ando Electric Co., Ltd.) in the condition of a temperature of 30° C. and a frequency of 1 kHz, thereby obtaining the volume resistivity of the colored particles.

4. Printing Evaluation of Toners

The printing evaluation of the toners of Examples 1 to 8 and Comparative Examples 1 to 7, was carried out. The details are as follows.

(1) Image Density

For image density measurement, a commercially-available, non-magnetic one-component development printer was used. The toner was packed in the toner cartridge of a development device, and printing paper sheets were loaded in the printer.

The printer was left under a normal-temperature and normal-humidity (N/N) environment (temperature: 23° C., humidity: 50%) for 24 hours. Then, under the same environment, while the amount of the toner loaded on each sheet was fixed at 0.3 mg/cm², continuous printing was carried out at an image density of 5%. This image density was kept from the beginning of the continuous printing.

After solid pattern printing (image density: 100%) was carried out on the tenth sheet, the image density of a solid image printed thereon was measured by means of a reflection image densitometer (product name: RD918, manufactured by: Macbeth Process Measurements Co.)

(3) Fog Test

Printing paper sheets were loaded in the commercially-available, non-magnetic one-component development printer (printing rate: 28 sheets/min). The toner was put into the development device. Then, the printer was left under a high-temperature and high-humidity (H/H) environment (temperature: 35° C., humidity: 80% RH) for 24 hours. Under the same environment, continuous printing was carried out on three sheets at an image density of 5%. Separately, printing paper sheets were loaded in the printer; the toner was put into the development device; the printer was left under a low-temperature and low-humidity (L/L) environment (temperature: 10° C., relative humidity: 20%) for 24 hours; and under the same environment, continuous printing was carried out on three sheets at an image density of 5%.

Thereafter, under each environment, continuous printing was carried out at a density of 5%. The density was kept from the beginning of the continuous printing. After 10,000 paper sheets were continuously printed, solid pattern printing (image density: 0%) was carried out. This solid pattern printing was stopped in the middle, and the toner on a non-image part on the photosensitive member after the developing, was peeled off by means of an adhesive tape and then attached to a new printing paper sheet. The color tones thereof were measured by using the above-mentioned reflection image densitometer and represented as coordinates on the L a b space. A color difference ΔE was calculated therefrom and determined as a fog value. A smaller fog value means less fog.

5. Conclusion from Toner Evaluation

Table 1 shows the results of the evaluation of the positively-chargeable black toners of Examples 1 to 8 and Comparative Examples 1 to 7. In the following Table 1, “Copolymerization ratio (%)” means the copolymerization ratio (% by mass) of the quaternary ammonium salt group-containing (meth)acrylate monomer in the three kinds of charge control resins (FCA-676P, FCA-592P and FCA161P) which are quaternary ammonium salt group-containing copolymers. Also in the following Table 1, each of “Content of charge control resin”, “Content of quaternary ammonium salt group-containing acrylate monomer unit” and “Content of carbon black” means the content (parts by mass) of each component with respect to 100 parts by mass of the binder resin. Also in the following Table 1, “HH initial fog” means a fog value under the high-temperature and high-humidity (H/H) environment in the above-mentioned fog test, and “LL initial fog” means a fog value under the low-temperature and low-humidity (L/L) environment in the above-mentioned fog test.

TABLE 1

| | Example 1 | Example 2 | Example 3 | Example 4 | Example 5 | Example 6 | Example 7 | Example 8 |
|---|---|---|---|---|---|---|---|---|
| Characteristics of | | | | | | | | |
| colored resin | | | | | | | | |
| particles | | | | | | | | |
| Colored resin | Colored | Colored | Colored | Colored | Colored | Colored | Colored | Colored |
| particles | resin | resin | resin | resin | resin | resin | resin | resin |
| | particles | particles | particles | particles | particles | particles | particles | particles |
| | (1) | (2) | (3) | (4) | (5) | (6) | (7) | (8) |
| Charge control | FCA-676P | FCA-676P | FCA-676P | FCA-676P | FCA-676P | FCA-676P | FCA-592P | FCA-592P |
| resin | | | | | | | | |
| Content of charge | 3.7 | 3.7 | 3.7 | 3.7 | 3.5 | 4.7 | 1.7 | 1.7 |
| control resin | | | | | | | | |
| (parts) | | | | | | | | |
| Copolymerization | 1 | 1 | 1 | 1 | 1 | 1 | 2 | 2 |
| ratio (%) | | | | | | | | |
| Content of | 0.037 | 0.037 | 0.037 | 0.037 | 0.035 | 0.047 | 0.034 | 0.034 |
| quaternary | | | | | | | | |
| ammonium salt | | | | | | | | |
| group-containing | | | | | | | | |
| acrylate monomer | | | | | | | | |
| unit | | | | | | | | |
| (parts) | | | | | | | | |
| Content of carbon | 10 | 11 | 12 | 13 | 12 | 12 | 10 | 12 |
| black | | | | | | | | |
| (parts) | | | | | | | | |
| Volume average | 5.8 | 5.6 | 5.7 | 5.7 | 5.7 | 5.6 | 5.9 | 5.9 |
| particle diameter | | | | | | | | |
| (μm) | | | | | | | | |
| Charge amount | 30 | 47 | 35 | 34 | 7 | 60 | 43 | 24 |
| (μC/g) | | | | | | | | |
| Electrical resistivity | 11.24 | 11.23 | 11.11 | 11.11 | 11.09 | 11.21 | 10.90 | 10.78 |
| log ρ | | | | | | | | |
| (Ω · cm) | | | | | | | | |
| Printing evaluation | | | | | | | | |
| Amount of toner | 0.3 | 0.3 | 0.3 | 0.3 | 0.3 | 0.3 | 0.3 | 0.3 |
| loaded on sheet | | | | | | | | |
| (mg/cm²) | | | | | | | | |
| Reflection I.D | 1.34 | 1.36 | 1.39 | 1.39 | 1.38 | 1.39 | 1.31 | 1.31 |
| LL initial fog | 0.4 | 0.9 | 0.6 | 0.6 | 0.2 | 1.7 | 0.8 | 0.4 |
| HH initial fog | 0.6 | 0.2 | 0.5 | 0.5 | 1.7 | 0.1 | 0.2 | 0.6 |

| | Comparative | Comparative | Comparative | Comparative | Comparative | Comparative | Comparative |
|---|---|---|---|---|---|---|---|
| | Example 1 | Example 2 | Example 3 | Example 4 | Example 5 | Example 6 | Example 7 |
| Characteristics of | | | | | | | |
| colored resin | | | | | | | |
| particles | | | | | | | |
| Colored resin | Colored | Colored | Colored | Colored | Colored | Colored | Colored |
| | resin | resin | resin | resin | resin | resin | resin |
| | particles | particles | particles | particles | particles | particles | particles |
| | (9) | (10) | (11) | (12) | (13) | (14) | (15) |
| Charge control | FCA-592P | FCA-161P | FCA-161P | FCA-161P | FCA-161P | FCA-676P | FCA-676P |
| resin | | | | | | | |
| Content of charge | 1.7 | 0.4 | 0.4 | 0.4 | 0.4 | 3.0 | 6.0 |
| control resin | | | | | | | |
| (parts) | | | | | | | |
| Copolymerization | 2 | 8 | 8 | 8 | 8 | 1 | 1 |
| ratio % | | | | | | | |
| Content of | 0.034 | 0.032 | 0.032 | 0.032 | 0.032 | 0.03 | 0.06 |
| quaternary | | | | | | | |
| ammonium salt | | | | | | | |
| group-containing | | | | | | | |
| acrylate monomer | | | | | | | |
| unit | | | | | | | |
| (parts) | | | | | | | |
| Content of carbon | 8 | 8 | 10 | 12 | 13 | 12 | 12 |
| black | | | | | | | |
| (parts) | | | | | | | |
| Volume average | 5.8 | 6.0 | 5.9 | 5.8 | 5.8 | 5.5 | 5.6 |
| particle diameter | | | | | | | |
| (μm) | | | | | | | |
| Charge amount | 32 | 18 | 35 | 24 | 31 | −2 | 82 |
| (μC/g) | | | | | | | |
| Electrical resistivity | 11.02 | 10.75 | 10.6 | 10.36 | 10.22 | 11.05 | 11.22 |
| log ρ | | | | | | | |
| (Ω · cm) | | | | | | | |
| Printing evaluation | | | | | | | |
| Amount of toner | 0.3 | 0.3 | 0.3 | 0.3 | 03 | 0.3 | 0.3 |
| loaded on sheet | | | | | | | |
| (mg/cm²) | | | | | | | |
| Reflection I.D | 1.24 | 1.18 | 1.24 | 1.24 | 1.24 | 1.38 | 1.39 |
| LL initial fog | 0.4 | 0.2 | 0.4 | 0.4 | 0.5 | 0.2 | 2.7 |
| HH initial fog | 0.5 | 1 | 0.5 | 0.6 | 0.5 | 3.5 | 0.1 |

Hereinafter, the toner evaluation will be discussed with reference to Table 1.

First, the toner of Comparative Example 1 will be discussed. According to Table 1, the toner of Comparative Example 1 is a toner using the charge control resin in which the copolymerization ratio of the quaternary ammonium salt group-containing (meth)acrylate monomer unit (hereinafter, it may be simply referred to as “copolymerization ratio”) is 1% by mass and containing 8 parts of the carbon black.

According to Table 1, the toner of Comparative Example 1 generated less fog since the LL initial fog is 0.4 and low, and the HH initial fog is 0.5 and low. However, the image density was low since the reflection ID is 1.24.

From these results, it is revealed that the toner of Comparative Example 1 using the charge control resin that has a copolymerization ratio of 2% by mass and containing 8 parts of the carbon black, cannot produce sharp black color in the condition that the amount of the toner loaded on the sheet is 0.3 mg/cm² and small.

Next, the toners of Comparative Examples 2 to 5 will be discussed. According to Table 1, the toners of Comparative Examples 2 to 5 are toners using the charge control resin in which the copolymerization ratio of the quaternary ammonium salt group-containing (meth)acrylate monomer unit (hereinafter it may be simply referred to as “copolymerization ratio”) is 8% by mass and containing 8 parts to 13 parts of the carbon black.

According to Table 1, the toners of Comparative Examples 2 to 5 generated less fog since the LL initial fog is 0.5 or less and low, and the HH initial fog is 1.0 or less and low. However, regardless of the content of the carbon black, the image density was low since the reflection ID is 1.24 or less.

From these results, it is revealed that even when the content of the carbon black was increased from 8 parts to 13 parts, the toners of Comparative Examples 2 to 5 using the charge control resin that has a high copolymerization ratio of 8% by mass, could not increase the image density in the condition that the amount of the toner loaded on the sheet is 0.3 mg/cm² and small.

As shown in Table 1, for the colored resin particles (10) to (13), as the content of the carbon black is increased from 8 parts to 13 parts, the electrical resistivity of the colored resin particles decreased from 10.75 Ω·cm to 10.22 Ω·cm. The reason why the image density does not increase even when, as described above, the amount of the carbon black is increased, is thought to be as follows: when the charge control resin having a high copolymerization ratio of 8% by mass is used, the carbon black aggregates inside the resin particles.

Next, the toner of Comparative Example 6 will be discussed. According to Table 1, for the toner of Comparative Example 6, the content of the carbon black is 12 parts, and the blow-off charge amount of the colored resin particles constituting the toner is −2 μC/g.

According to Table 1, for the toner of Comparative Example 6, the image density is high since the reflection ID is 1.38, and the LL initial fog is 0.2 and low. However, the HH initial fog was 3.5 and very high.

From these results, it is revealed that the toner of Comparative Example 6 is likely to generate initial fog in the high-temperature and high-humidity environment, since the blow-off charge amount of the colored resin particles constituting the toner is −2 μC/g and too low.

Next, the toner of Comparative Example 7 will be discussed. According to Table 1, for the toner of Comparative Example 7, the content of the carbon black is 12 parts, and the blow-off charge amount of the colored resin particles constituting the toner is 82 μC/g.

According to Table 1, for the toner of Comparative Example 7, the image density is high since the reflection ID is 1.39, and the HH initial fog is 0.1 and low. However, the LL initial fog was 2.7 and very high.

From these results, it is revealed that the toner of Comparative Example 7 is likely to generate initial fog in the low-temperature and low-humidity environment, since the blow-off charge amount of the colored resin particles constituting the toner is 82 μC/g and too high.

Meanwhile, according Table 1, the toners of Examples 1 to 7 are toners in which the copolymerization ratio of the quaternary ammonium salt group-containing acrylate monomer unit in the quaternary ammonium salt group-containing copolymer is in a range of from 1% by mass to 2% by mass; the content of the carbon black is in a range of from 10 parts to 13 parts; and the blow-off charge amount of the colored resin particles is in a range of from 7 μC/g to 60 μC/g.

According to Table 1, for the toners of Examples 1 to 7, the image density is high since the reflection ID is 1.31 or more; the LL initial fog is 1.7 or less and low; and the HH initial fog was 1.7 or less and low.

Therefore, it is revealed that the toners of Examples 1 to 7 in which the copolymerization ratio of the quaternary ammonium salt group-containing (meth)acrylate monomer unit in the quaternary ammonium salt group-containing copolymer is in a range of from 1% by mass to 2% by mass; the content of the carbon black is in a range of from 10 parts by mass to 13 parts by mass, with respect to 100 parts by mass of the binder resin; and the blow-off charge amount of the colored resin particles is in a range of from 7 μC/g to 60 μC/g, are positively-chargeable black toners which can inhibit fog and which can produce sharp black color on a printed surface of a sheet, even in such a condition that the amount of the toner on the sheet is small.

1. A positively-chargeable black toner comprising colored resin particles containing a binder resin, carbon black and, as a charge control resin, a quaternary ammonium salt group-containing copolymer,
wherein the quaternary ammonium salt group-containing copolymer is a styrene acrylic polymer containing a quaternary ammonium salt group-containing (meth)acrylate monomer unit;
wherein a copolymerization ratio of the quaternary ammonium salt group-containing (meth)acrylate monomer in the quaternary ammonium salt group-containing copolymer, is in a range of from 0.1% by mass to 2.5% by mass;
wherein a content of the carbon black is in a range of from 10 parts by mass to 15 parts by mass with respect to 100 parts by mass of the binder resin; and
wherein a blow-off charge amount of the colored resin particles measured by a charge amount measuring method mentioned below, is in a range of from 5 μC/g to 60 μC/g:
first, 0.25 g of the colored resin particles and 9.75 g of a ferrite carrier (spherical, non-resin-coated) are put in a 30 cc glass container (inside bottom diameter: 30 mm, height: 50 mm); using a roller mixer, the glass container is rotated at 160 rotations per minute (rpm) for 30 minutes to carry out a triboelectric charging treatment in an environment of 23° C. and a relative humidity of 50%;
after the triboelectric charging treatment, 0.2 g of a mixture of the colored resin particles and the ferrite carrier is put in a Faraday gauge; and using a blow-off powder charge amount measuring device, the blow-off charge amount (μC/g) of the colored resin particles is measured by blowing off for 30 seconds in a condition of a nitrogen gas pressure of 0.098 MPa.

2. The positively-chargeable black toner according to claim 1, wherein the positively-chargeable black toner is a polymerized toner.

3. The positively-chargeable black toner according to claim 1, wherein the ferrite carrier used in the charge amount measuring method is a standard carrier EF-80B2 (product name, manufactured by: Powdertech Corporation, Mn—Mg—Sr—Fe-based, spherical, non-resin coated, particle diameter: 80 μm), and the blow-off powder charge amount measuring device is MODEL TB200 (product name, manufactured by: Toshiba Chemical Corporation).

4. The positively-chargeable black toner according to claim 2, wherein the ferrite carrier used in the charge amount measuring method is a standard carrier EF-80B2 (product name, manufactured by: Powdertech Corporation, Mn—Mg—Sr—Fe-based, spherical, non-resin coated, particle diameter: 80 μm), and the blow-off powder charge amount measuring device is MODEL TB200 (product name, manufactured by: Toshiba Chemical Corporation).
